(19) United States
(12) Patent Application Publication
(10) Pub. No.: US 2014/0156135 A1
(43) Pub. Date: Jun. 5, 2014

(54) VEHICLE CONTROL DEVICE FOR RAILROAD VEHICLE AND VEHICLE CONTROL SYSTEM FOR RAILROAD VEHICLE

(71) Applicant: KABUSHIKI KAISHA TOSHIBA, Tokyo (JP)

(72) Inventors: Yasuomi MAKI, Tokyo (JP); Youko YAMAMOTO, Tokyo (JP); Hiroaki YOSHINARI, Tokyo (JP)

(73) Assignee: KABUSHIKI KAISHA TOSHIBA, Tokyo (JP)

(21) Appl. No.: 14/092,520

(22) Filed: Nov. 27, 2013

(30) Foreign Application Priority Data
Nov. 30, 2012 (JP) 2012-263608

(51) Int. Cl. H04L 12/931; G07C 5/00

(52) U.S. Cl. CPC H04L 49/35; G07C 5/008
USPC 701/29.1; 370/328

(57) ABSTRACT

A vehicle control device for a first railroad vehicle includes a case, a first wireless router device housed in the case, and an antenna device. The antenna device is installed on any of outer peripheral surfaces of the case. The first wireless router device transmits collected operation data of the vehicle control device via the antenna device and a first wireless communication network to a second wireless router device arranged in a second railroad vehicle so that a gateway router also arranged in the second railroad vehicle can transmit the collected operation data to an external server via a second wireless communication network.

### CROSS-REFERENCE TO RELATED APPLICATION

This application is based upon and claims the benefit of priority from Japanese Patent Application No. 2012-263608, filed Nov. 30, 2012; the entire contents of which are incorporated herein by reference.

### FIELD

Embodiments described herein relate generally to a vehicle control device for a railroad vehicle and a vehicle control system for a railroad vehicle.

### BACKGROUND

Vehicle control devices that are mounted in railroad vehicles and control the vehicles have been known. The operation state of multiple vehicle control devices that are mounted in railroad vehicles has been provided by a monitor of the vehicles. Therefore, when all or part of the vehicle control devices is out of order, the monitor can specify the vehicle control devices that are out of order.

However, in the related art, defective parts of vehicle control devices and causes of the fault cannot be specified. In addition, with regard to components constituting the vehicle control device, the need for their maintenance when they have been degraded due to aging and/or environmental conditions is difficult to detect, and when the vehicle control devices are broken, these devices have to be replaced or exchanged. They also need to be maintained within a certain period at an appropriately set timing.

### DESCRIPTION OF THE DRAWINGS

FIG. 1 is an illustrative diagram showing an example of a railroad vehicle control system according to embodiments.

FIGS. 2A to 2D are illustrative diagrams showing an example of the vehicle control device of a first embodiment.

FIGS. 3A to 3C are illustrative diagrams showing an example of the vehicle control device of a second embodiment.

FIGS. 4A and 4B are illustrative diagrams showing an example of the vehicle control device of a third embodiment.

FIGS. 5A and 5B are illustrative diagrams showing an example of the vehicle control device of a fourth embodiment.

FIGS. 6A and 6B are illustrative diagrams showing an example of the vehicle control device of a fifth embodiment.

FIGS. 7A and 7B are illustrative diagrams showing an example of the vehicle control device of a sixth embodiment.

FIGS. 8A and 8B are illustrative diagrams showing an example of the vehicle control device of a seventh embodiment.

FIGS. 9A and 9B are illustrative diagrams showing an example of the vehicle control device of an eighth embodiment.

FIGS. 10A and 10B are illustrative diagrams showing an example of the vehicle control device of a ninth embodiment.

FIG. 11 is an illustrative diagram showing an example of the vehicle control device of a tenth embodiment.

FIG. 12 is an illustrative diagram showing the case in which two units or more of multiple vehicle control devices are mounted in one vehicle.

### DETAILED DESCRIPTION

Embodiments provide a vehicle control device for a railroad vehicle and a vehicle control system for a railroad vehicle that can collect information for easily deciding the integrity of each component of the vehicle control device.

In general, the embodiments will be explained with reference to the figures.

The vehicle control device for a first railroad vehicle of the embodiments includes a case, a first wireless router device housed in the case, and an antenna device installed on any of the outer peripheral surfaces of the case. The first wireless router device of the vehicle control device transmits collected operation data of the vehicle control device via the antenna device and a first wireless communication network to a second wireless router device arranged in a second railroad vehicle so that a gateway router also arranged in the second railroad vehicle can transmit the collected operation data to an external server via a second wireless communication network.

### First Embodiment

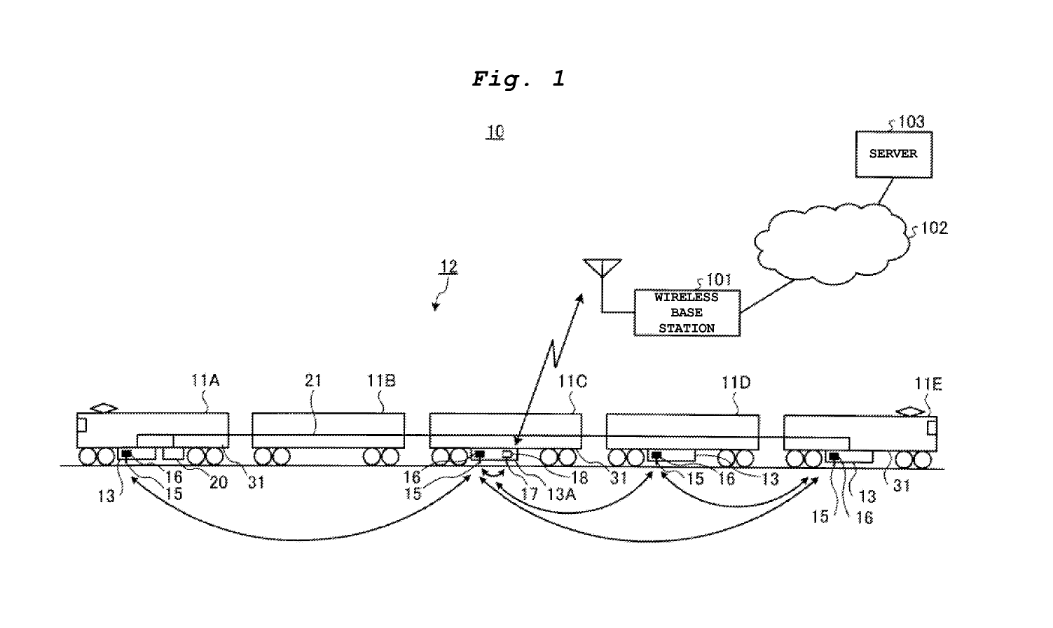

FIG. 1 is an illustrative diagram showing an example of the railroad vehicle control system according to embodiments.

A railroad vehicle control system 10 has a railway train 12 that includes railroad vehicles 11A-11E to be controlled and a server 103 that collects operation data of vehicle control devices 13 and 13A from the vehicle control devices 13 and 13A, which are mounted on any number (e.g., five in FIG. 1) of railroad vehicles 11A-11E, via a wireless base station 101 and a public communication network 102 functioning as ground-side access points, decides an operation state of the vehicle control devices 13 and 13A or each part constituting the vehicle control devices 13 and 13A, and carries out notification processing on whether or not maintenance is required, warning processing, etc.

Here, the operation data include information showing the operation state of the vehicle control devices 13 and 13A or data indicating degradation-state or life of each part (components) constituting the vehicle control devices 13 and 13A.

The railroad vehicles 11A, 11D, and 11E are mounted with a motor for driving, not shown in the figure, and the vehicle control device 13, and function as control power vehicles having steering wheels. In addition, the vehicle control device 13 is provided with a wireless LAN router 16 having an antenna 15.

Moreover, a motor for driving not shown in the figure, and the vehicle control device 13A are mounted on the railroad vehicle 11C. Furthermore, the vehicle control device 13A has the wireless LAN router 16 with the antenna 15 and an antenna 17 and is provided with a gateway router 18 that can communicate between each wireless LAN router 16 and the wireless base station 101.

In addition, the railroad vehicle 11B is a trailer vehicle.

Here, using a wireless communication network between the antenna 15 of the railroad vehicle 11C and the antenna 15 of each of the railroad vehicles 11A, 11D, and 11E, the vehicle control devices 13 of the railroad vehicles 11A, 11D, and 11E send the operation data of each part constituting the vehicle control devices 13 to the vehicle control device 13A so that the wireless router 16 of the vehicle control device 13A can transmit, from the antenna 17 of the gateway router 18 connected to the wireless router 16, the collected operation data to the wireless base station 101 through w-WAN (wireless-Wide Area Network). The data received at the wireless base station 101 arrive at the server 103 via the communication network 102. Meanwhile, the wireless router 16 and its antenna 15 may relay the control data, transmitted by the vehicle control device 13 of the railroad vehicle 11E, to the vehicle control device 13A.

Furthermore, a central vehicle control device (TCMS: Train Control and Monitoring System) 20 is mounted on the railroad vehicle 11A, and each of vehicle control devices 13 and 13A is connected by a wire LAN 21 comprised of Ethernet®, etc., and provides control, monitoring, inspection, repair, and other kinds of services of the railroad vehicles 11A-11E of the central vehicle control device 20.

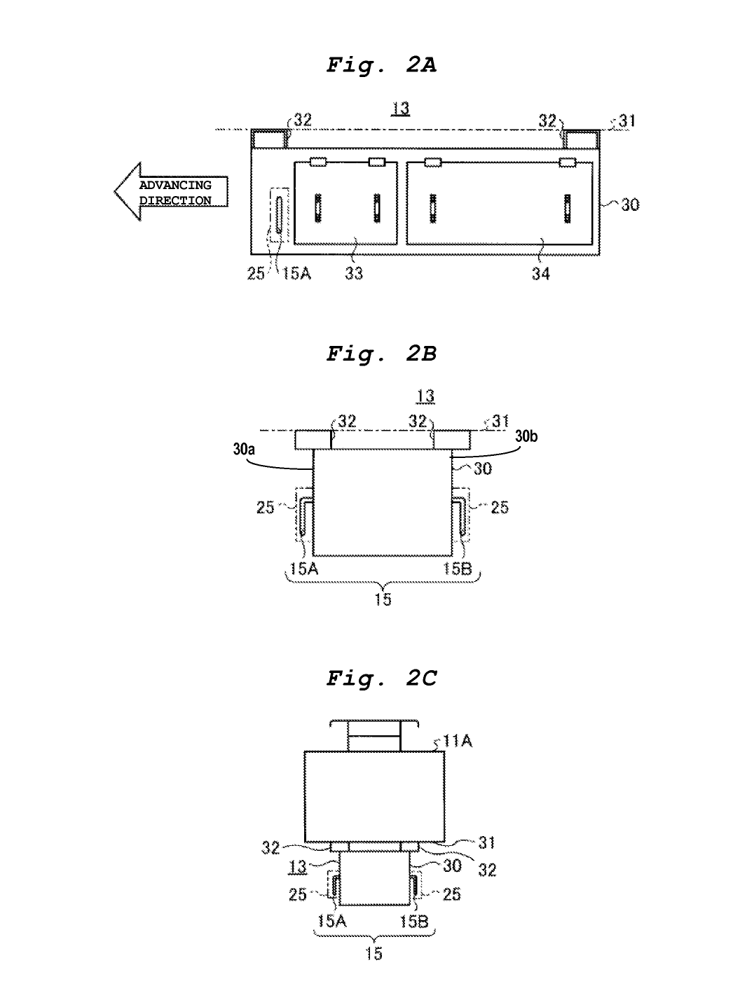

FIGS. 2A to 2D are illustrative diagrams showing an example of the vehicle control device of a first embodiment.

FIG. 2A is a front view showing the vehicle control device. FIG. 2B is a side view showing the vehicle control device. FIG. 2C is an illustrative diagram showing a mounting state of the vehicle control device into a railroad vehicle. FIG. 2D is an illustrative diagram showing the arrangement of each part in the vehicle control device.

The vehicle control device 13 has a case 30 and is mounted on a floor bottom face 31 of the railroad vehicles 11A, 11C, 11D, and 11E as shown in FIG. 2A and FIG. 2C by suspension metal fitting parts 32 and fastening parts such as bolts and nuts not shown in the figures.

At the front of the vehicle control device 13, a first door 33 and a second door 34 are installed; various kinds of maintenance can be carried out by setting these doors to an open state.

At the front and the back of the vehicle control device 13, as shown in FIG. 2B and FIG. 2D, a pair of antenna 15A and antenna 15B constituting the antenna 15 protrude to the outer surface of the case 30.

The case 30, as shown in FIG. 2C, is installed in the central part (the central part in the width direction of the railroad vehicle) of the floor bottom face 31 of a railroad vehicle 11.

In addition, the antenna 15A, as shown in FIG. 2B, is installed on a first side surface 30a of the case 30, and the antenna 15B is installed on a second side surface 30b of the case 30.

Here, the reason for the installation of a pair of antenna 15A and antenna 15B is space diversity (i.e., to increase the antenna coverage area and increase precision of the data communication), etc.

Moreover, protective covers 25 made of a resin are respectively installed to protect the antenna 15A and the antenna 15B from dirt, etc. In this case, as the protective covers, transparent or opaque resins can be used.

Furthermore, to protect the antenna 15A and the antenna 15B from flying articles such as dirt, stones, wind and rain, and for antitheft measures, the protective covers 25 made of a resin or a material such as glass fiber-reinforced plastic, which can transmit radio waves, are respectively installed. In this case, the protective covers are transparent, semitransparent, or opaque.

Here, the antenna 15A and the antenna 15B are separated by a spacing of one wavelength or longer so that the interference of reception states may be suppressed. With the installation of a spacing having a designated value or greater between the antennas, each antenna can be effectively used.

As shown in FIG. 2D, in the case 30, the wireless LAN router 16 is positioned forward in the advancing direction of the railroad vehicles 11A-11E. The wireless LAN router 16 and the antennas 15A and 15B are connected in a state in which an impedance matching is realized by each coaxial cable 35.

In addition, in the case 30, a power conversion unit 36 such as a VVVF inverter (variable voltage/variable frequency control inverter) for driving the driving motor and a control unit 37 for controlling the power conversion driving unit 36 under the control of the central vehicle control device 20 are installed. The power conversion unit 36 may contain both the VVVF inverter and a SIV (static inverter) for supplying electric power to lights and air-conditioners and so on.

Here, the wireless LAN router 16 is installed on the side of the control unit 37 away from the power conversion driving unit 36 to further reduce influences such as the heat of the power conversion driving unit 36 that is generated when the railroad vehicles 11A-11E advance.

The wireless LAN router 16 can also be positioned at the lower side (rail side) of the control unit 37, at the upper side (vehicle side) of the control unit 37, or between the control unit 37 and the first door 33. With the arrangement of the wireless LAN router at these positions, the wireless LAN router is mounted in a peripheral area equivalent to the control unit 37. For this reason, the degradation of the wireless LAN router due to the influence of heat, etc., from the power conversion driving unit 36 can be suppressed.

The control unit 37 is installed as a low-voltage circuit, the power conversion unit 36 is installed as a high-voltage circuit, and the wireless router 16 is installed as a low voltage.

Next, the outlined operation will be explained.

The central vehicle control unit 20 mounted in the railroad vehicle 11A ascertains states of appliances constituting the vehicle control devices 13 and 13A via the wire LAN 21 and displays the appliance states. In addition, if the appliances constituting the vehicle control devices 13 and 13A are out of order, the central vehicle control device 20 ascertains the appliance fault state and carries out the necessary appliance fault-treatment processing (notification, change to a redundant system or a substitute system), service appliance control for controlling service appliances such as the display appliance in the vehicle, passenger support processing, test processing on the vehicle for various kinds of tests on the vehicle, which can be checked on the vehicle, driving-state recording processing for recording the driving situations, operation recording of various kinds of appliances, etc.

Along with these types of processing, the wireless LAN router 16 collects data for the operation states (for example, voltage value, current value, temperature, frequency, operation times of contact components, time, component positions, etc.) of each part constituting the control unit 37 or each part constituting the power conversion driving unit 36, which are obtained via the control unit 37 as operation data via a LAN cable 38 and transfers the data to the wireless LAN router 16 constituting the vehicle control device 13A via the antenna 15A and the antenna 15B by radio.

In this case, the sampling timing, etc., of the operation data are appropriately preset in accordance with the operation data to be processed. In addition, to reduce the load of the communication network, if necessary, data compression, etc., are carried out. Moreover, in the operation data, as mentioned above, data for the degradation-state decision or life decision of each part (components) constituting the vehicle control devices 13 and 13A are included, and information (vehicle number, MAC address, etc.) for specifying the vehicle control device 13, information for specifying the appliances corresponding to each of the operation data, information on the collection timing (occurrence time, position information) of the operation data, and information such as the voltage value, current value, temperature, and frequency in a certain terminal indicating check position of each component, as well as operation times of the contact components, acquisition time of the operation data, and component position for specifying each component are included.

Furthermore, among the operation data, there are data for comparing the power with the regenerative power of each vehicle control device in the vehicle configuration 12 during operation, which are basic data for changing the control application (or operating system) so that the power efficiency is further raised.

Therefore, the wireless LAN router 16 constituting the vehicle control device 13A collects the data on the operation state of each part constituting the control unit 37 of the vehicle control device 13A or each part constituting the power conversion driving unit 36, which are obtained via the control unit 37, as operation data via the LAN cable 38 and transfers the collected operation data as packet data to the gateway router 18 via the antenna 15A and the antenna 15B by radio (or wire). Here, since the wireless LAN router 16 of the vehicle control device 13 can also function as a bridge, this router also has the role of bridging to simply transmit the operation data received from routers 16 of other vehicle control devices 13 to the gateway router 18.

From these results, the control unit 37 detects whether or not the wireless base station 101 exists in its own communication area to transmit the collected operation data of all the vehicle control devices 13 and 13A to a server 103.

Next, if the wireless base station 101 does not exist in the communication area of the control unit 37, the data are retransmitted.

Therefore, if the wireless base station 101 exists in the communication area of the control unit 37, data (information and time for specifying the vehicle 12 and data in which the collected operation data are synthesized) prepared in advance are converted into packet data and transmitted to the wireless base station 101 by radio.

Here, the reason why the information for specifying the vehicle configuration 12 is also included is that the units to be processed are specified.

As explained above, according to the first embodiment, since the antenna 15A is installed at the front of the case 30 of the vehicle control devices 13 and 13A and the antenna 15B is installed at the back, the operation data can be transmitted and received between two side surfaces of the railroad vehicle.

In addition, according to this embodiment, if the vehicle control devices are positioned in the central part in the axle direction of the railroad vehicle (the central part in the width direction of the railroad vehicle), information from two vehicle side-surface directions can be obtained.

Moreover, if antennas are installed in the railroad vehicle 11A and the railroad vehicle 11C using the configuration of this embodiment, the distance between a pair of assumed antennas and the direction thereof can be aligned. For this reason, scattering of the wireless environment due to the installation state between the vehicles can be reduced.

As explained above, since the transmission and reception system of the operation data is a system that is different from the data transmission and reception system (wire LAN 21) of the control system of the vehicle configuration 12, the operation data can be collected without having an influence on the control system of the vehicle configuration 12.

As a result, in the server 103, since detailed operation data indicating the degradation-state or life of each part (components) constituting the vehicle control devices 13 and 13A can be collected, information for easily deciding the operation state of each part (components) constituting the vehicle control devices 13 and 13A can be collected, so that the components can be exchanged before going out of order according to the fault-diagnosis program or the instructions of the operator, or an appropriate maintenance period can be set adaptively to the operation state.

Furthermore, since the data transmission and reception system (wire LAN 21) of the control system of the vehicle configuration 12 is adopted as a separate system, the control of the vehicle configuration 12 is not affected (decrease of real-time controllability, etc.), and detailed operation data of the vehicle control devices 13 and 13A can be collected even in a configuration in which the central vehicle control device 20 does not exist), so that the operation data can be analyzed in detail in the server 103. Based on this analysis result, a control application (or operating system) of each device constituting the vehicle control device 13 or vehicle control device 13A can be further approximated to the actual operation of each device constituting the vehicle control device 13 or vehicle control device 13A, thus being able to provide a guideline for improving the power efficiency.

In addition, since the structure in which the operation data of the entire vehicle configuration 12 are transmitted to the server 103 via one gateway router 18 is adopted, the communication cost in W-WAN can be suppressed.

### Second Embodiment

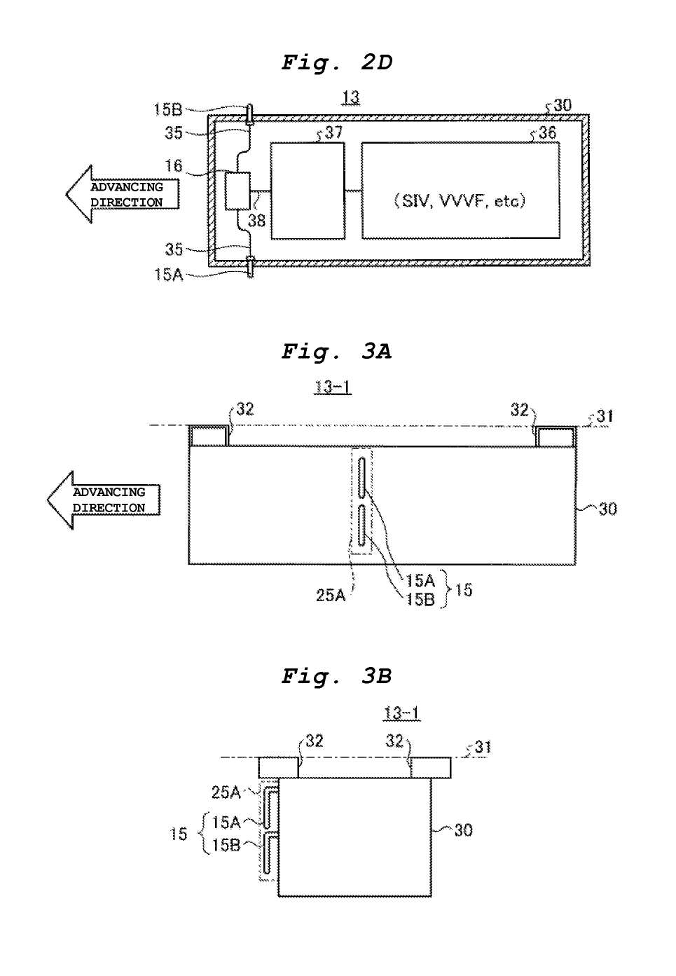

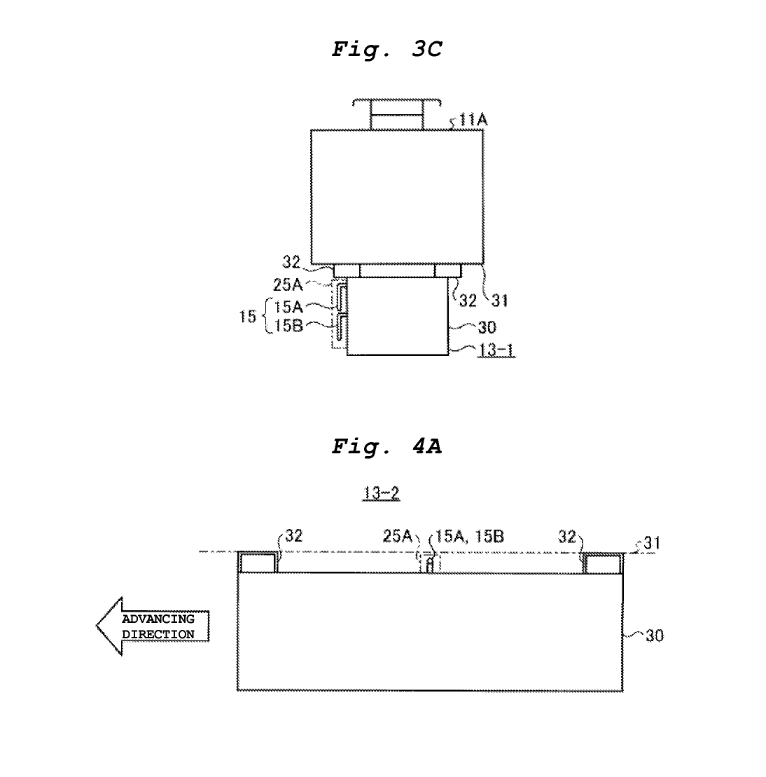

FIGS. 3A to 3C are illustrative diagrams showing an example of the vehicle control device of a second embodiment.

In FIGS. 3A to 3C, the same symbols are given to parts similar to the parts of FIG. 2. In addition, in FIG. 3, for simplicity of drawing, the first door and the second door are not shown in the figure.

FIG. 3A is a front view showing the vehicle control device. FIG. 3B is a side view showing the vehicle control device. FIG. 3C is an illustrative diagram showing the mounting state of the vehicle control device on a railroad vehicle.

Similarly to the vehicle control device 13 of the first embodiment, a vehicle control device 13-1 of the second embodiment has the case 30 and is mounted on the floor bottom face 31 of the railroad vehicles 11A-11E as shown in FIG. 3A by the suspension metal fitting parts 32 and fastening parts such as bolts and nuts not shown in the figures.

At the front of the vehicle control device 13-1, as shown in FIG. 3A and FIG. 3B, a pair of antennas 15A and 15B constituting the antenna 15 protrude to the outer surface of the case 30. Here, the reason for the installation of the pair of antennas 15A and 15B is space diversity, etc.

In addition, to protect the antenna 15A and the antenna 15B from dirt, etc., a protective cover 25A made of a material such as a resin, which can transmit radio waves, is installed.

In this case, similarly to the first embodiment, the antenna 15A and the antenna 15B are also separated by a spacing of one wavelength or longer so that the interference of reception states may be suppressed.

At that time, the case 30, as shown in FIG. 3C, is installed in an outer part (outer part in the width direction of the railroad vehicle) in the axle direction of the floor bottom face 31 of the railroad vehicle 11.

Since the other operations are similar to the operations of the first embodiment, their detailed explanation is omitted.

As explained above, according to the second embodiment, since the antenna 15A and the antenna 15B are installed in parallel in the vertical direction at the front of one easy communication side of the case 30 of the vehicle control device 13-1, similarly to the first embodiment, operation data can be transmitted and received between the railroad vehicles; also since the two antennas 15A and 15B are arranged on one surface, drawing or maintenance of a coaxial cable is made easy. With the alignment of the position (distance) and the direction between the respective vehicles, scattering of the wireless state can be reduced.

In addition, with the installation of two or more multiple antennas on one side surface of a good vehicle, each antenna can technically receive radio waves from multiple directions and it is possible to improve the stability and speed of wireless communication, however, in consideration of the vehicle state during driving, which is a communication by a wireless bridge connection, even if the route approaches a mildly curved area, the radio waves can be easily passed through this area.

### Third Embodiment

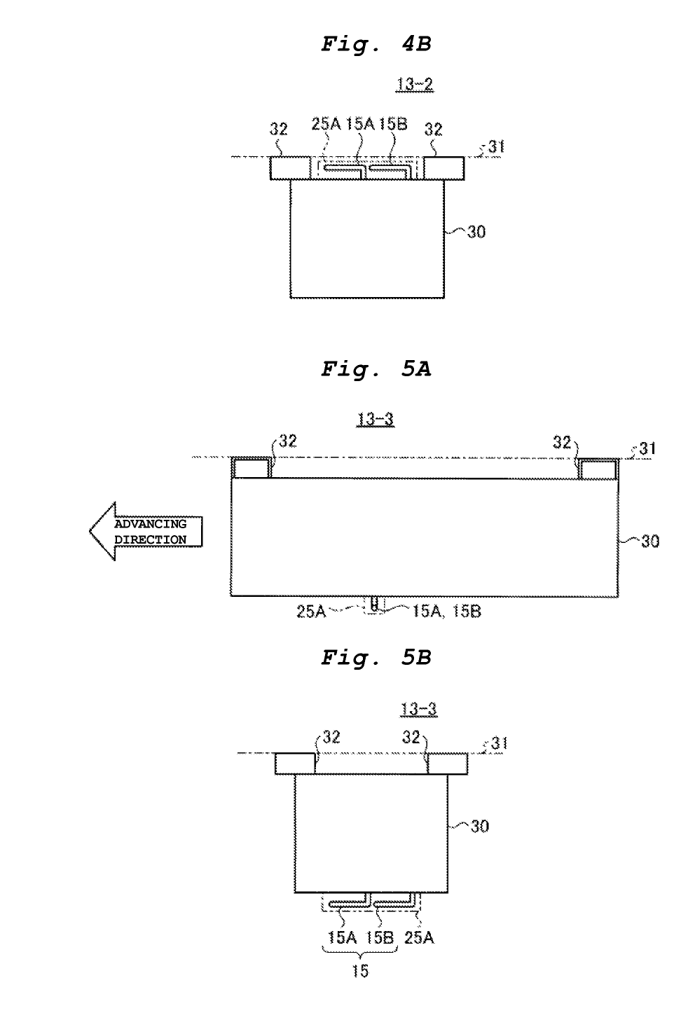

FIGS. 4A and 4B are illustrative diagrams showing an example of the vehicle control device of a third embodiment.

In FIGS. 4A and 4B, the same symbols are given to parts similar to the parts of FIGS. 3A to 3C. In addition, in FIGS. 4A and 4B, for simplicity of drawing, the first door and the second door are not shown in the figure.

FIG. 4A is a front view showing the vehicle control device. FIG. 4B is a side view showing the vehicle control device.

Similarly to the vehicle control device 13-1 of the second embodiment, a vehicle control device 13-2 of the third embodiment has the case 30 and is mounted on the floor bottom face 31 of the railroad vehicles 11A-11E as shown in FIG. 4A by the suspension metal fitting parts 32 and fastening parts such as bolts and nuts not shown in the figures.

On the ceiling surface (upper surface) of the vehicle control device 13-2, as shown in FIG. 4A and FIG. 4B, a pair of antennas 15A and 15B constituting the antenna 15 are horizontally protruded to the outer surface of the case 30. Here, the reason for the installation of a pair of antennas 15A and 15B is space diversity.

In addition, to protect the antenna 15A and the antenna 15B from dirt, etc., the protective cover 25A made of a resin, etc., is installed.

In this case, similarly to the first embodiment, the antenna 15A and the antenna 15B are also separated by a spacing of one wavelength or longer so that the interference of reception states may be suppressed.

Since the other operations are similar to the operations of the first embodiment, their detailed explanation is omitted.

As explained above, according to the third embodiment, since the antenna 15A and the antenna 15B are installed in parallel in the horizontal direction on the ceiling surface of the case 30 of the vehicle control device 13-2, operation data can be reliably transmitted and received between the railroad vehicles.

In addition, since the two antennas 15A and 15B are arranged between the floor bottom face 31 of the railroad vehicles and the ceiling surface of the case 30, if a space where there are no wirings colliding with articles at the periphery of the railroad vehicles can be secured, the antennas can be protected.

### Fourth Embodiment

FIGS. 5A and 5B are illustrative diagrams showing an example of the vehicle control device of a fourth embodiment.

In FIGS. 5A and 5B, the same symbols are given to parts similar to the parts of FIG. 3. In addition, in FIGS. 5A and 5B, for simplicity of drawing, the first door and the second door are not shown in the figure.

FIG. 5A is a front view showing the vehicle control device. FIG. 5B is a side view showing the vehicle control device.

Similarly to the vehicle control device 13-1 of the second embodiment, a vehicle control device 13-3 of the fourth embodiment has the case 30 and is mounted on the floor bottom face 31 of the railroad vehicles 11A-11E as shown in FIG. 5A by the suspension metal fitting parts 32 and fastening parts such as bolts and nuts not shown in the figures.

On the lower surface (bottom face) of the vehicle control device 13-3, as shown in FIG. 5A and FIG. 5B, a pair of antennas 15A and 15B constituting the antenna 15 horizontally protrude to the outer surface of the case 30. Here, the reason for the installation of a pair of antennas 15A and 15B is space diversity.

In addition, to protect the antenna 15A and the antenna 15B from dirt, etc., the protective cover 25A made of a resin, etc., is installed.

In this case, similarly to the first embodiment, the antenna 15A and the antenna 15B are also separated by a spacing of one wavelength or longer so that the interference of reception states may be suppressed.

Since the other operations are similar to the operations of the first embodiment, their detailed explanation is omitted.

As explained above, according to the fourth embodiment, since the antenna 15A and the antenna 15B are installed in parallel in the horizontal direction on the lower surface of the case 30 of the vehicle control device 13-3, if a continuous space can be secured between the vehicles and railroad ties, operation data can be transmitted and received between the railroad vehicles.

In addition, since the two antennas 15A and 15B are arranged on the lower surface of the case 30, the maintenance can be carried out simply by drawing a coaxial cable or slipping the coaxial cable under the vehicles, making the maintenance easy. Since the antennas are installed in a place that is difficult to be seen, the antitheft feature of the antennas is enhanced.

### Fifth Embodiment

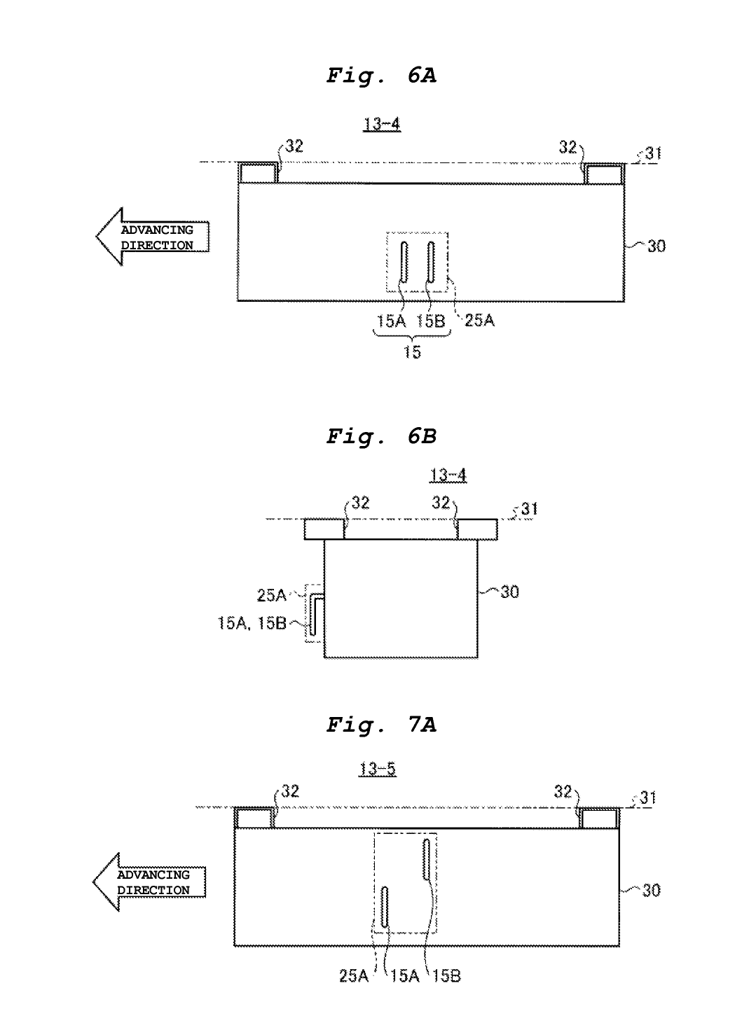

FIGS. 6A and 6B are illustrative diagrams showing an example of the vehicle control device of a fifth embodiment.

In FIGS. 6A and 6B, the same symbols are given to parts similar to the parts of FIG. 3. In addition, in FIGS. 6A and 6B, for simplicity of drawing, the first door and the second door are not shown in the figure.

FIG. 6A is a front view showing the vehicle control device. FIG. 6B is a side view showing the vehicle control device.

The difference between the fifth embodiment of FIGS. 6A and 6B and the second embodiment of FIGS. 3A to 3C is that the two antennas 15A and 15B are arranged in parallel along the advancing direction of vehicles at the front of the case 30.

Therefore, the antenna 15A of the fifth embodiment easily communicates with the antenna 15B of other vehicle control devices installed in railroad vehicles in the approaching and advancing direction. Similarly, the antenna 15B of the fifth embodiment easily communicates with the antenna 15A of other vehicle control devices installed in railroad vehicles in the direction opposite to the approaching and advancing direction. Due to an antenna cover with an oblong shape, this arrangement is sometimes preferable in terms of shape.

Since the other operations are similar to the operations of the first embodiment and the second embodiment, their detailed explanation is omitted.

As explained above, according to the fifth embodiment, since the antenna 15A and the antenna 15B are installed in parallel (parallel) in the vertical direction at the front of the case 30 of a vehicle control device 13-4, operation data can be reliably transmitted and received between the railroad vehicles.

In addition, since the two antennas 15A and 15B are arranged at the front of the case 30, similarly to the second embodiment, drawing and maintenance of a coaxial cable are made easy.

### Sixth Embodiment

FIGS. 7A and 7B are illustrative diagrams showing an example of the vehicle control device of a sixth embodiment.

In FIGS. 7A and 7B, the same symbols are given to parts similar to the parts of FIGS. 6A and 6B. In addition, in FIGS. 7A and 7B, for simplicity of drawing, the first door and the second door are not shown in the figure.

FIG. 7A is a front view showing the vehicle control device. FIG. 7B is a side view showing the vehicle control device.

The difference between the sixth embodiment of FIGS. 7A and 7B and the fifth embodiment of FIGS. 6A and 6B is that when the two antennas 15A and 15B are arranged in parallel in the advancing direction of vehicles at the front of the case 30, these antennas are arranged with a shift in the vertical direction.

Therefore, the antennas 15A and 15B of the sixth embodiment do not cause an interference between the antennas 15A and 15B, compared with the antennas 15A and 15B of the fifth embodiment.

Since the other operations are similar to the operations of the first embodiment and the second embodiment, their detailed explanation is omitted.

As explained above, according to the sixth embodiment, since the antenna 15A and the antenna 15B are installed with a shift in the vertical direction while arranging the antennas in parallel (parallel) in the vertical direction at the front of the case 30 of a vehicle control device 13-5, similarly to the first embodiment, operation data can be reliably transmitted and received between the railroad vehicles.

In addition, since the two antennas 15A and 15B are arranged at the front of the case 30, similarly to the second embodiment, drawing and maintenance of a coaxial cable are made easy. In case an antenna cover is separated for convenience of shape or the like, this arrangement is preferable.

### Seventh Embodiment

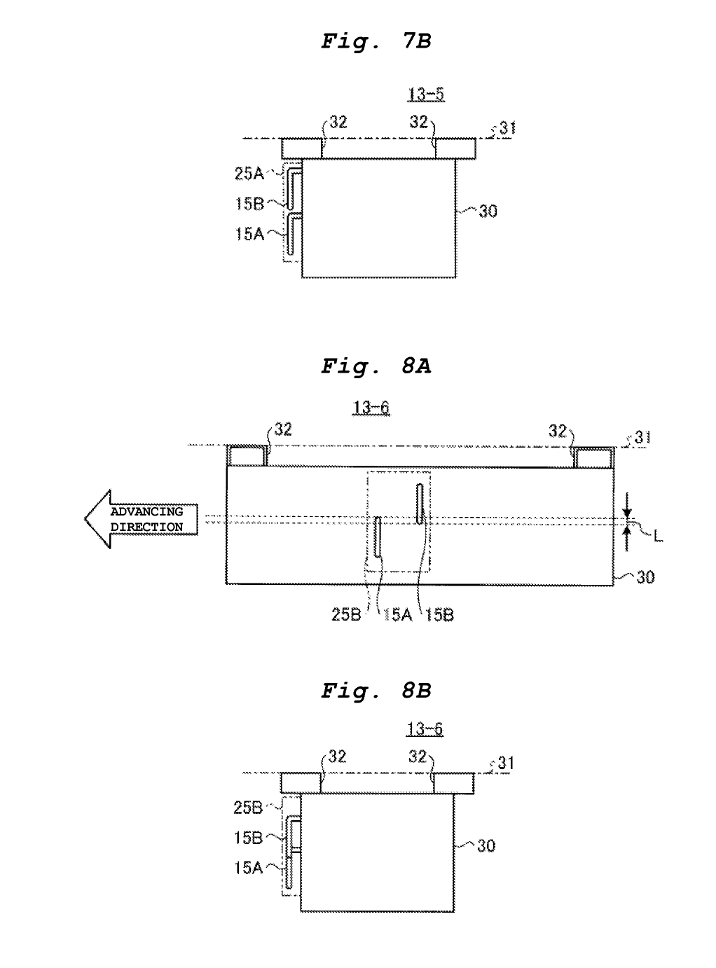

FIGS. 8A and 8B are illustrative diagrams showing an example of the vehicle control device of a seventh embodiment.

In FIGS. 8A and 8B, the same symbols are given to parts similar to the parts of FIGS. 7A and 7B. In addition, in FIGS. 8A and 8B, for simplicity of drawing, the first door and the second door are not shown in the figure.

FIG. 8A is a front view showing the vehicle control device. FIG. 8B is a side view showing the vehicle control device.

The difference between the seventh embodiment of FIGS. 8A and 8B and the sixth embodiment of FIGS. 7A and 7B is that the two antennas 15A and 15B are arranged in a partially overlapping manner from the side surface view of the case 30 (only the length L is overlapped in the figure).

In addition, a protective cover 25B made of a resin, etc., is installed to protect the antenna 15A and the antenna 15B from dirt, etc.

According to this embodiment, while maintaining a transmission and reception performance similar to the performance of the sixth embodiment, the protective cover 25B can be formed so that this protective cover is smaller than the protective cover 25A of the sixth embodiment, thus being able to reduce the installation area.

Since the other operations are similar to the operations of the first embodiment and the second embodiment, their detailed explanation is omitted.

As explained above, according to the seventh embodiment, since the antenna 15A and the antenna 15B are arranged in a partially overlapping manner from the side surface view of the case 30 while arranging the antennas in parallel (parallel) in the vertical direction at the front of the case 30 of a vehicle control device 13-6, the installation area is small, and operation data can be transmitted and received between the railroad vehicles while maintaining a transmission and reception performance similar to the performance of the sixth embodiment.

In addition, since the two antennas 15A and 15B are arranged at the front of the case 30, similarly to the second embodiment, drawing and maintenance of a coaxial cable are made easy.

### Eighth Embodiment

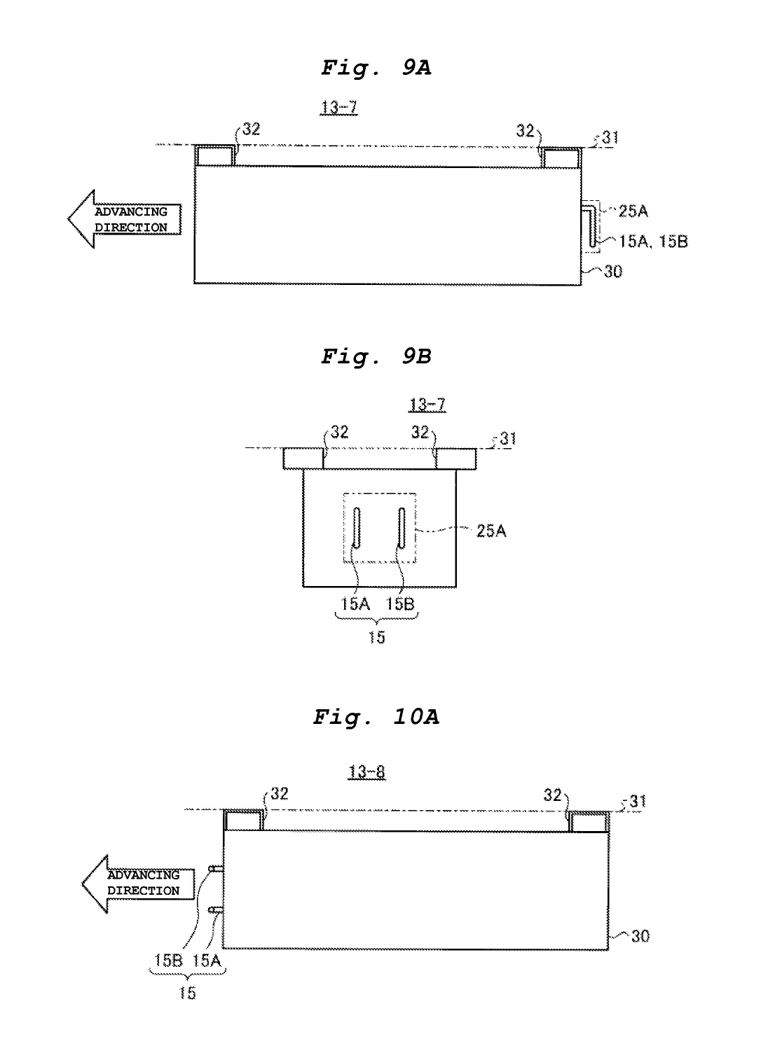

FIGS. 9A and 9B are illustrative diagrams showing an example of the vehicle control device of an eighth embodiment.

In FIGS. 9A and 9B, the same symbols are given to parts similar to the parts of FIGS. 6A and 6B. In addition, in FIGS. 9A and 9B, for simplicity of drawing, the first door and the second door are not shown in the figure.

FIG. 9A is a front view showing the vehicle control device. FIG. 9B is a side view showing the vehicle control device.

The difference between the eighth embodiment of FIGS. 9A and 9B and the fifth embodiment of FIGS. 6A and 6B is that the two antennas 15A and 15B are arranged in parallel in the vertical direction on the rear side surface of the case 30.

In this case, similarly to the first embodiment, the antenna 15A and the antenna 15B are also separated by a spacing of one wavelength or longer so that the interference of reception states may be suppressed.

Since the other operations are similar to the operations of the first embodiment, their detailed explanation is omitted.

As explained above, according to the eighth embodiment, since the antenna 15A and the antenna 15B are installed in parallel in the vertical direction on the rear side surface of the case 30 of a vehicle control device 13-7, similarly to the first embodiment, operation data can be transmitted and received between the railroad vehicles.

In addition, since the two antennas 15A and 15B are arranged on the rear side surface of the case 30, drawing and maintenance of a coaxial cable are made easy.

The above explanation involves the case in which the two antennas 15A and 15B are arranged on the rear side surface of the case 30; however a configuration in which the two antennas 15A and 15B are arranged on the front side surface of the case 30 can also be adopted.

### Ninth Embodiment

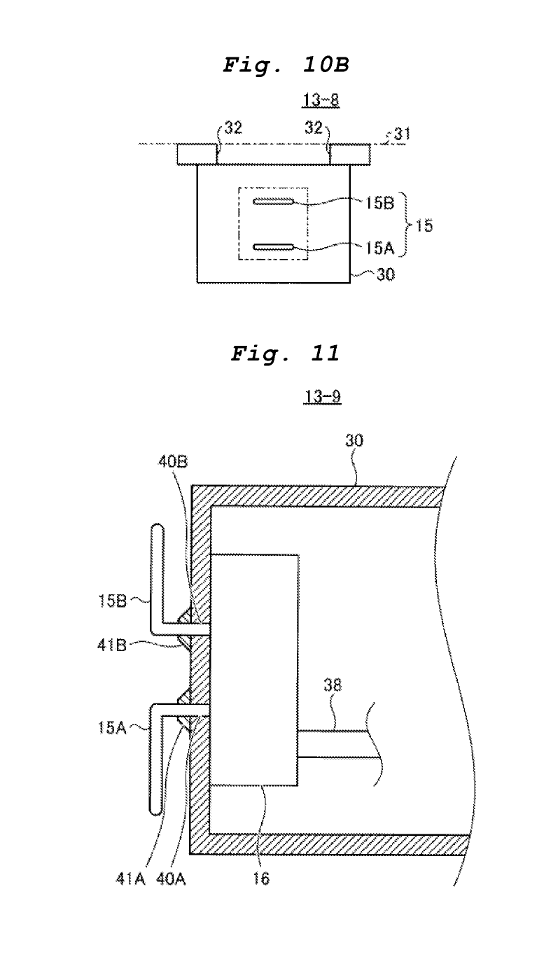

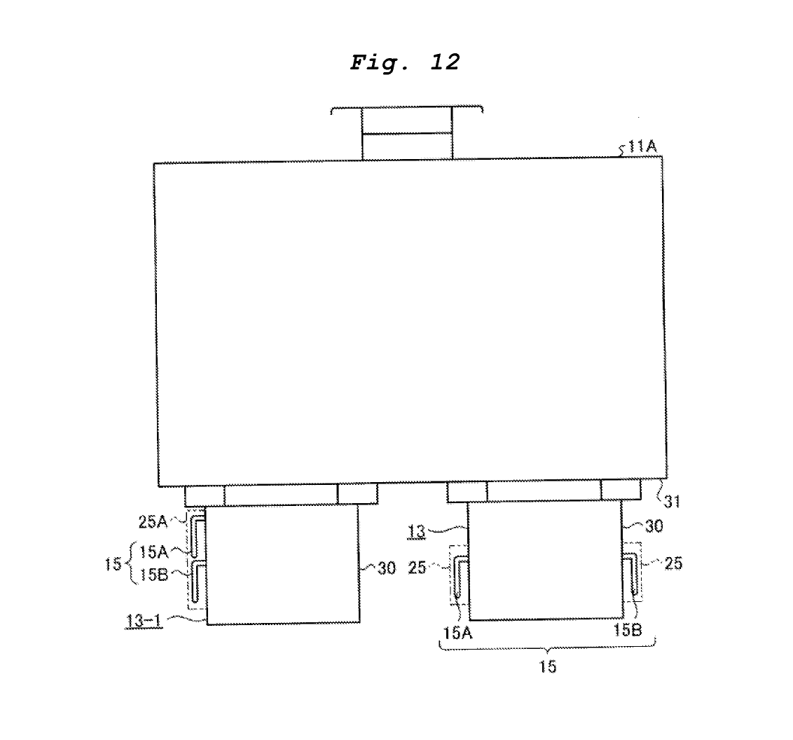

FIGS. 10A and 10B are illustrative diagrams showing an example of the vehicle control device of a ninth embodiment.

In FIGS. 10A and 10B, the same symbols are given to parts similar to the parts of FIGS. 9A and 9B. In addition, in FIGS. 10A and 10B, for simplicity of drawing, the first door and the second door are not shown in the figure.

FIG. 10A is a front view showing the vehicle control device. FIG. 10B is a side view showing the vehicle control device.

The difference between the ninth embodiment of FIGS. 10A and 10B and the eighth embodiment of FIGS. 9A and 9B is that the two antennas 15A and 15B are arranged in parallel in the horizontal direction on the front side surface of the case 30.

In this case, similarly to the first embodiment, the antenna 15A and the antenna 15B are also separated by a spacing of one wavelength or longer so that the interference of reception states may be suppressed.

Since the other operations are similar to the operations of the first embodiment, their detailed explanation is omitted.

As explained above, according to the ninth embodiment, since the antenna 15A and the antenna 15B are installed in parallel in the horizontal direction on the front side surface of the case 30 of the vehicle control device 13-7, similarly to the first embodiment, operation data can be reliably transmitted and received between the railroad vehicles.

In addition, since the two antennas 15A and 15B are arranged on the front side surface of the case 30 near a place where a wireless LAN router and a control unit are installed, drawing and maintenance of a coaxial cable are made easy.

The above explanation involves the case in which the two antennas 15A and 15B are arranged on the front side surface of the case 30; however, a configuration in which the two antennas 15A and 15B are arranged on the rear side surface of the case 30 can also be adopted.

### Tenth Embodiment

The above respective embodiments involve the case in which the two antennas 15A and 15B as an antenna device are electrically connected via a wireless LAN router and a coaxial cable and are installed on a designated outer peripheral surface of the case; however, the tenth embodiment involves the case in which the two antennas 15A and 15B are mechanically fixed to the wireless LAN router 16.

FIG. 11 is a partial cross section showing a tenth embodiment.

In a vehicle control device 13-9 of the tenth embodiment, the antennas 15A and 15B are directly fixed to the wireless LAN router 16 by screws.

In addition, the antennas 15A and 15B are installed on the outer peripheral surface of the case 30 in a state in which the antennas penetrate through the case 30 via through holes 40A and 40B installed in the case 30 of the vehicle control device 13-9.

Moreover, the periphery of the through holes 40A and 40B is covered with packing parts 41A and 41B, preventing water, dirt, etc., from being introduced into the case 30 from the outside.

As explained above, according to the tenth embodiment, since the drawing of a coaxial cable in the case 30 is not required in addition to effects similar to the effects of the first embodiment, the installation of the wireless LAN router 16 and the antennas 15A and 15B is made easier.

The arrangement of the wireless LAN router of the above embodiment is only an example and can be changed so that the arrangement follows the description of this embodiment in accordance with the arrangement of the control unit, circuit breaker, etc., in a power conversion driving unit.

### Eleventh Embodiment

In the above respective embodiments, the case in which one vehicle control device is mounted in a railroad vehicle has been explained; however, the case in which multiple vehicle control devices are mounted in a railroad vehicle can also be applied.

FIG. 12 is an illustrative diagram showing the case in which two units or more of multiple vehicle control devices are mounted in one vehicle.

In case vehicle control devices such as the vehicle control device 13 and the vehicle control device 13-1 are mounted, as shown in FIG. 12, if antennas are respectively installed at optimum positions of each vehicle control device 13 and 13-1, an optimum wireless environment can be constructed as an optimally organized vehicle.

In this case, the above respective embodiments can be appropriately applied.

In addition, for example, a combined structure of the first embodiment and the other embodiments can be considered. Moreover, a combined structure consisting of only one side of the first embodiment and the other embodiments can be considered. In this case, a spacing with a designated value or greater is also secured between antennas.

### Modified Example of Embodiments

In the above explanation, the case of a vehicle configuration having a central vehicle control device (TCMS) has been explained. However, in a vehicle configuration having no central vehicle control device (TCMS), an operation data transmission substrate and a wireless LAN router may be built in each vehicle control device, a cellular router may be installed in a device for radio data transmission with an external w-WAN, and antennas for radio communications may be located at the positions where communications are possible in each vehicle control device.

In the above explanation, operation data have been transmitted (packet data communication) during the operation of the vehicle configuration; however, operation data that do not have to be transmitted immediately can also be collectively transmitted by a vehicle service base, etc.

In the above explanation, one gateway router is installed in one vehicle configuration, however a configuration in which multiple gateway routers are installed in one vehicle configuration in accordance with the capacity of operation data, etc. can also be adopted.

In the above explanation, the case in which the transmission of the gateway router cannot be completed has not been explained. However, even when communications are not completely finished because of degradation of the radio wave situation, etc., if there is a ground-side access point that can transmit data, the transmission can be retried until the data transfer is completed.

In the above explanation, the case in which two antennas are installed has been explained; however, three or more antennas can be installed, or communications can be carried out using one antenna, such as in frequency diversity, etc. In this case, a configuration for diversity reception is not necessarily required.

In the above explanation, as a diversity system, a space diversity system is employed; however, as a more detailed diversity system, either an antenna selection system for selecting antennas in a good reception state or a maximum-ratio synthesis system for matching and synthesizing phases of reception signals of the two antennas 15A and 15B are applicable. In addition, without being limited to the space diversity, polarized wave diversity, angle diversity, etc., are also applicable. The communication system is not limited to only that of diversity, meaning that a system for improving radio stability and substantially increasing a speed by multiple antennas can be mounted. In any cases, preferably, two or more antennas or multiple antennas exist physically.

In the above explanation, in a vehicle configuration in which a central vehicle control device (TCMS) is mounted, the transmission of operation data occurs in a system that is different from the control system of the central vehicle control device. However, with the connection of each vehicle control device and the vehicle central control device by a communication network such as Ethernet®, operation data that are transmitted from the vehicle control devices may be generalized in real time, and instructions may be transmitted to each vehicle control device by the central vehicle control device. Here, in this case, the central vehicle control device also transmits and receives the operation data and the instructions to and from the ground side by radio communications.

In the above explanation, the installation positions of the antennas of the wireless LAN router and the arrangement relation with the doors of the case have not been distinctly mentioned; however, the antennas of the wireless LAN router can be installed at positions where the doors of the case are not installed or on the doors.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A vehicle control device for a first railroad vehicle, comprising:
a case;
an antenna device connected to a first wireless router device; and
the first wireless router device housed in the case and configured to transmit collected operation data of the vehicle control device via a first wireless communication network, established between the antenna device and an antenna connected to a second wireless router device, to the second wireless router device arranged in a second railroad vehicle so that a gateway router also arranged in the second railroad vehicle can transmit the collected operation data to an external server via a second wireless communication network.

2. The vehicle control device according to claim 1, wherein the antenna device includes multiple antennas.

3. The vehicle control device according to claim 2, wherein the antennas are installed on different outer peripheral surfaces of the case.

4. The vehicle control device according to claim 2, wherein the antennas are installed on the same outer peripheral surface of the case.

5. The vehicle control device according to claim 4, wherein the antennas extend vertically and extension directions of the antennas are parallel to each other.

6. The vehicle control device according to claim 5, wherein center positions of the antennas are at substantially the same height.

7. The vehicle control device according to claim 5, wherein center positions of the antennas are at different heights.

8. The vehicle control device according to claim 6, wherein an upper position of one of the antennas is higher than a lower position of another of the antennas.

9. The vehicle control device according to claim 1, wherein the antenna device is electrically connected to the first wireless router device via a coaxial cable.

10. The vehicle control device according to claim 1, wherein the antenna device extends through the case to be directly connected to the first wireless router device.

11. A vehicle control system for a railroad vehicle, comprising:
a gateway router configured to transmit operation data to an external server via a first wireless communication network;
a wireless router device that is housed in a case and mounted on the railroad vehicle, and configured to collect and transmit the operation data to the gateway router via a second wireless communication network; and
an antenna device that is connected to the wireless router device for establishing the second wireless communication network.

12. The vehicle control system according to claim 11, wherein
the gateway router is configured to transmit the operation data to the external server by packet communication.

13. The vehicle control system according to claim 12, wherein the vehicle control device is configured to update a control application or an operating system based on data received via the gateway router.

14. The vehicle control system according to claim 11, wherein
the operation data includes data indicating the operation state of the vehicle control device, data indicating the degradation state of each component of the vehicle control device, and data indicating life of each component of the vehicle control device.

15. The vehicle control system according to claim 11, wherein
the wireless router device is configured to relay operation data, which have been transmitted by other wireless router devices of other vehicle control devices mounted on other railroad vehicles to the wireless router device.

16. The vehicle control system according to claim 11, wherein the antenna device includes multiple antennas that are installed on different outer peripheral surfaces of the case.

17. A method of managing operation data for a plurality of railroad vehicles that are connected in series, comprising:
collecting operation data of the railroad vehicles at a wireless router device that is housed in a case and mounted on one of the railroad vehicles;
transmitting the collected operation data of the railroad vehicles from the wireless router device to a gateway router via a first wireless communication network; and
transmitting the collected operation data from the gateway router to an external server via a second wireless communication network,
wherein an antenna device is connected to the wireless router device and the collected operation data is transmitted from the wireless router device to the gateway router through the antenna device.

18. The method of claim 17, wherein the antenna device is installed on any of outer peripheral surfaces of the case.

19. The method of claim 17, further comprising:
receiving operation data from wireless router devices of other railroad vehicles via the first wireless communication network through the antenna device.

20. The method of claim 17, further comprising:
receiving operation data through the gateway router; and
updating a control application or an operating system based on the operation data received through the gateway router.
